(19) United States
(12) Patent Application Publication
(10) Pub. No.: US 2004/0080590 A1
(43) Pub. Date: Apr. 29, 2004

(54) Ink cartridge with air bubbles inflowing regularly

(75) Inventors: Myung-Song Jung, Gunpo-city (KR); Young-Su Lee, Suwon-cirty (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., LTD, Suwon-city (KR)

(21) Appl. No.: 10/685,466

(22) Filed: Oct. 16, 2003

(30) Foreign Application Priority Data
Oct. 16, 2002 (KR) 2002-63146

(51) Int. Cl. B41J 2/175

(52) U.S. Cl. 347/87

(57) ABSTRACT

An ink cartridge including a foam chamber generating negative pressure, with an air passage formed from an upper end thereof toward a lower end, an ink filter and an ink head. A part of a bottom of the foam chamber slopes down and the foam is disposed inside the foam chamber. An ink chamber storing ink is disposed at one side of the foam chamber and is divided from the foam chamber by a partition having a connecting opening connecting the ink chamber with the foam chamber. A cartridge cover closes upper ends of the ink chamber and foam chamber and has an ink inlet. The air passage is formed vertically and close to the partition and the air passage is disposed to slope such that a lower end thereof inclines toward the partition more than an upper end. Further, it is the connecting opening is formed at a lowest end of the partition and the ink filter is disposed at a position lower than the connecting opening.

### CROSS-REFERENCE TO RELATED APPLICATIONS

This application claims the benefit of Korean Application No. 2002-63146, filed Oct. 16, 2002, in the Korean Intellectual Property Office, the disclosure of which is incorporated herein by reference.

### BACKGROUND OF THE INVENTION

1. Field of the Invention

The present invention relates to an ink cartridge, and more particularly, to an ink cartridge with air bubbles inflowing regularly, capable of stably using ink inside an ink chamber.

2. Description of the Related Art

Generally, an inkjet printer has an ink cartridge installed into an ink carriage to print. The inkjet printer moves the ink cartridge installed in the ink carriage to the left or right to spray ink onto a paper through an ink head.

The ink cartridge of the inkjet printer is generally divided into a foam chamber 101 and ink chamber 102 as shown in FIG. 1.

The foam chamber 101 has a rectangular cross-section and has a flat bottom. The foam chamber 101 and ink chamber 102 are divided by a partition 107, and the partition 107 is provided at a lower portion with a connecting opening 104 to allow the foam chamber 101 and ink chamber 102 to communicate. A slot 100 is cut into one side of the partition 107 to flow air bubbles.

The foam chamber 101 includes a foam 103 that generates negative pressure and an upper portion with an ink inlet (not shown) injecting ink thereinto. The foam chamber 101 is further provided at one side with a filter compressor 106 for compressing the foam 103 so that ink flows toward an ink filter (not shown).

The ink chamber 102 stores ink. Ink flows by a predetermined amount into the foam chamber 101 through the connecting opening 104 when ink inside the foam chamber 101 is exhausted through an ink head (not shown).

With the above conventional ink cartridge, upon injecting ink through the ink inlet (not shown), the ink is absorbed into the foam 103 inside the foam chamber 101 and also flows into the ink chamber 102 through the connecting opening 104. The foam 103 holds ink uniformly throughout the whole surface except in a vicinity of the filter compressor 106 in which the foam 103 is severely compressed and holds more ink.

With the conventional ink cartridge, ink in the vicinity of the filter compressor 106 flows toward the ink filter (not shown) and the flowed ink is sprayed onto a paper through the ink head (not shown). When the ink flows out of the ink chamber 102, negative pressure inside the ink chamber 102 rises so that outside air flows into the foam chamber 101 through the ink inlet (not shown). The inflowed air forms air bubbles 105 that flow down along the slot 100 formed on the one side of the partition 107 and then into the ink chamber 102 through the connecting opening 104 formed at the lower portion of the partition 107.

When the air bubbles flow into the ink chamber 102, a volume of ink corresponding to a volume of the air bubbles stored inside the ink chamber 102, flows into the foam chamber 101 through the connecting opening 104 and toward the filter compressor 106. The flowed ink is then sprayed onto the paper through the ink head (not shown).

Since the conventional ink cartridge is provided with the long slot 100 formed on the one side of the partition 107 dividing the ink chamber 102 from the foam chamber 101 for flowing air bubbles, large amounts of air bubbles flow into the ink chamber 101 without any difficulty and further without any relation to a degree of negative pressure inside the foam chamber 101, thereby causing air bubbles to inflow irregularly and much faster than the printing speed.

When the amount of ink flowing into the foam chamber 101 changes abruptly from time to time as described above, negative pressure inside the foam chamber 101 fluctuates severely and even decreases below a proper degree. Therefore the flow of ink cannot be regulated to cause a suitable amount of ink to flow to the ink head. Excessive amounts of ink flowing to the ink head degrades the printing quality.

Further, a process of cutting the slot to allow air bubbles to flow through has to be added to a molding process of the conventional ink cartridge and thus the structure of the ink cartridge become more complex, thereby reducing the life span of the ink cartridge.

### SUMMARY OF THE INVENTION

An aspect of the invention is to solve the above and/or other problems and disadvantages and to provide at least the advantages described hereinafter.

Accordingly, one aspect of the present invention is to solve the foregoing and/or other problems by providing an ink cartridge allowing air bubbles to inflow regularly into an ink chamber and is capable of stably using ink inside the ink chamber.

Another aspect of the present invention is to provide an ink cartridge with improved printing quality by allowing air bubbles to regularly inflow into an ink chamber according to negative pressure inside a foam chamber and providing a suitable amount of ink to an ink head.

The foregoing and/or other objects and advantages are realized by providing an ink cartridge comprising: a foam chamber generating negative pressure, including a foam with an air passage formed from an upper end thereof toward a lower end, an ink filter and an ink head, wherein a part of a bottom of the foam chamber slopes down and the foam is disposed inside the foam chamber; an ink chamber storing ink, disposed at one side of the foam chamber and divided from the foam chamber by a partition having a connecting opening connecting the ink chamber with the foam chamber; and a cartridge cover closing upper ends of the ink chamber and foam chamber and having an ink inlet.

In an embodiment of the invention, a cross section of the air passage is a circle or a polygon.

In another embodiment of the invention, the air passage is formed vertically and close to the partition and the air passage is disposed to slope such that a lower end thereof inclines toward the partition more than an upper end.

Furthermore, in another embodiment of the invention, the connecting opening is formed a lowest end of the partition and the ink filter is at a lower position than the connecting opening.

According to the invention, the ink injection member is used to form an air passage inside the foam. Thus the air bubbles flow into the ink chamber regularly according to the changes of negative pressure inside the foam chamber. This allows the ink inside the ink chamber to be stably used.

Further, an angle and length of the air passage inside the foam chamber can be changed so air bubbles can flow regularly into the ink chamber.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings in which like reference numerals refer to like elements wherein:

FIG. 1 is a cross sectional view showing a conventional ink cartridge;

FIG. 2 is a cross sectional view showing an ink cartridge in accordance with an embodiment of the invention, in which an ink injection member is inserted into a foam chamber to inject ink into the cartridge;

FIGS. 3 and 4 are perspective views schematically showing air passages formed on foams received by foam chambers in accordance with other embodiments of the invention, respectively; and

FIGS. 5 and 6 are cross sectional views showing slopes of air passages formed inside foams in accordance with yet other embodiments of the invention.

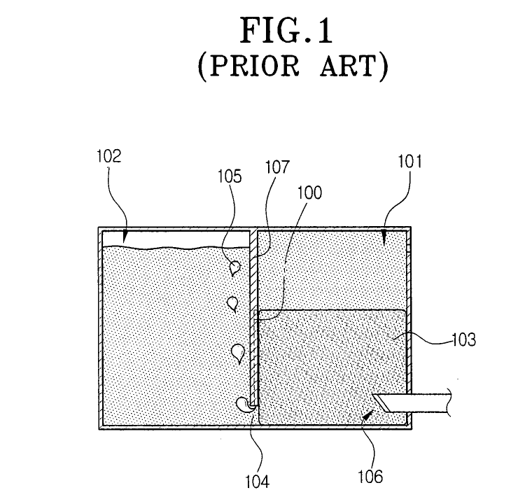

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

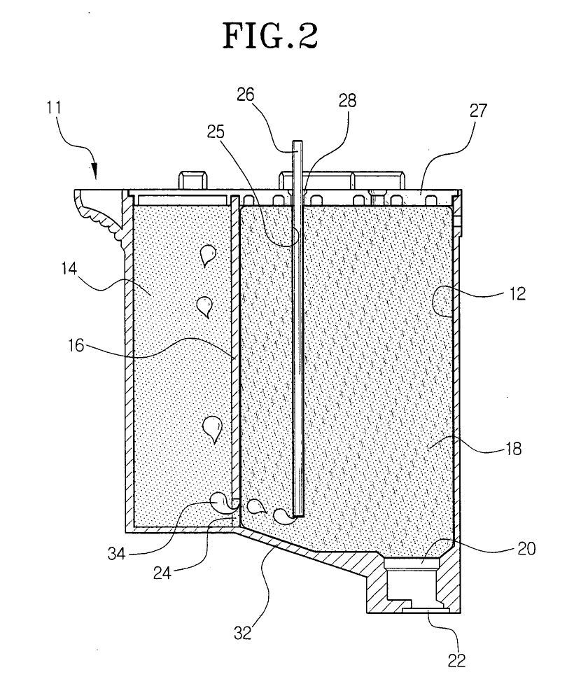

FIG. 2 is a cross sectional view showing an ink cartridge in accordance with an embodiment of the invention, in which an ink injection member is inserted into a foam chamber for injecting ink into the cartridge.

As shown in FIG. 2, the ink cartridge comprises a foam chamber 12, an ink chamber 14, a cartridge cover 27, an ink filter 20 and an ink head 22.

The foam chamber 12 is provided inside with a foam 18 having an air passage 25 formed thereinto. At a bottom 32 are the ink filter 20 and ink head 22 under the ink filter 20. The bottom 32 of the foam chamber 12 slopes down toward the ink filter 20.

The ink chamber 14 is disposed at one side of the foam chamber 12 and is divided from the foam chamber 12 by a partition 16. The partition 16 is provided at a lower portion with a connecting opening 24 connecting the ink chamber 14 and the foam chamber 12.

The cartridge cover 27 closes upper ends of the ink chamber 14 and foam chamber 12. The cartridge cover 27 is provided with an ink inlet 28 injecting ink and communicating inside of the foam chamber with outer air.

As shown in FIG. 2, an ink injection member 26 is inserted vertically through the foam 18 inside the foam chamber 12 upon injecting ink into the ink cartridge 11. Ink is filled into the foam chamber 12 and the ink chamber 14 through the inserted ink injection member 26 and then the ink injection member 26 is removed. After removing the ink injection member 26, the inside of the foam 18 where the ink injection member was inserted changes in structure so that an air passage 25 corresponding to the volume of the ink injection member 26 is formed. The ink injection member 26 may be anything shaped like a hollow stick such as a needle that injects ink.

Upon printing with the above construction of the invention, ink in the foam chamber 12 flows into the ink head 22 through the ink filter 20 and is sprayed onto a paper. When a predetermined amount of ink flows out of the ink chamber 14, negative pressure is generated inside the foam chamber 12 and outer air flows into the foam chamber 12, which has a lower pressure, through the ink inlet 28.

The inflowed air forms air bubbles 34 inside ink and flows downward through the air passage 25 formed in the foam 18. When the air bubbles 34 reach a lower end of the air passage 25 they are blocked from flowing by the compressed foam 18, and then flow upward along the sloped bottom 32 of the foam chamber 12 into the ink chamber 14 through the connecting opening 24 in an amount corresponding to the negative pressure formed inside the foam chamber 12. That is, the amount of air flowing into the ink chamber 14 corresponds to the uniform amount of the ink flowing out of the foam chamber 12.

The air passage 25 formed in the foam 18 provides the air bubbles 34 with a passage in order to reach the bottom 32 of the foam chamber 12. The sloped shape of the bottom 32 of the foam chamber 12 helps the light air bubbles 34 flow into the ink chamber 14 along the slope.

With the above construction, negative pressure inside the foam chamber 12 changes according to the amount of ink consumed through the ink head 22, and thus the air bubbles 34 flow into the ink chamber 14 uniformly according to the changes of the negative pressure so that ink inside the ink chamber can be stably used.

Further, the invention has an advantage in that an angle and length of the ink injection member 26 can be adjusted to control the time when ink flows into the ink chamber 14.

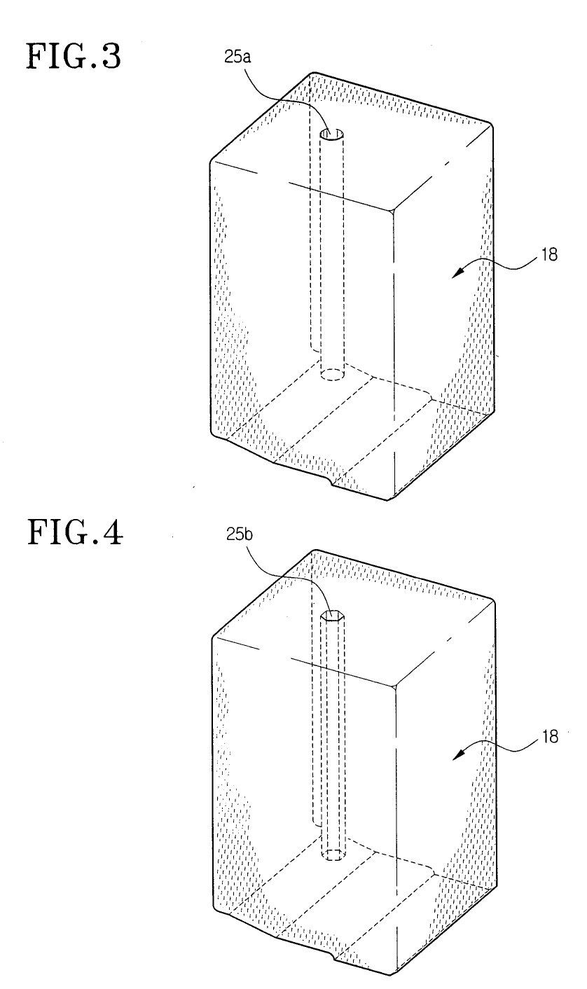

FIGS. 3 and 4 are perspective views schematically showing air passages formed on foams received by foam chambers in accordance with other embodiments of the invention, respectively.

As shown in the drawings, cross sectional shapes of the air passages in the foams are formed as a circle 25a or polygon 25b by changing cross sectional shapes of ink injection members. Thus, resistance, which is applied to air bubbles flowing downward therethrough, can be controlled.

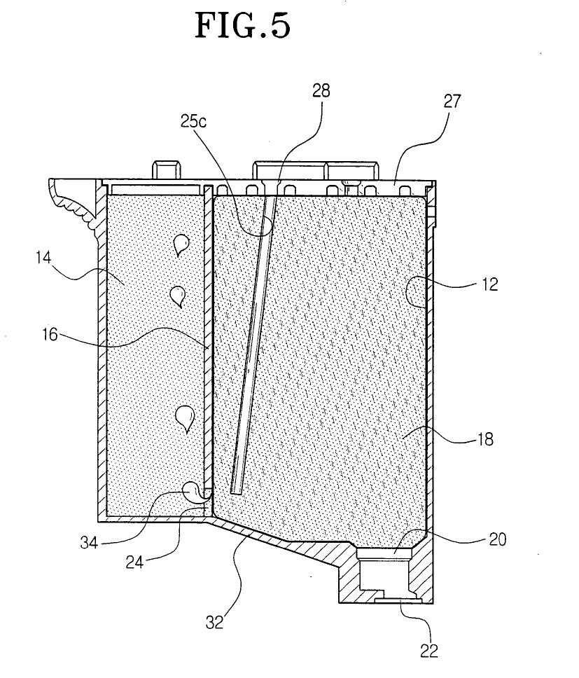

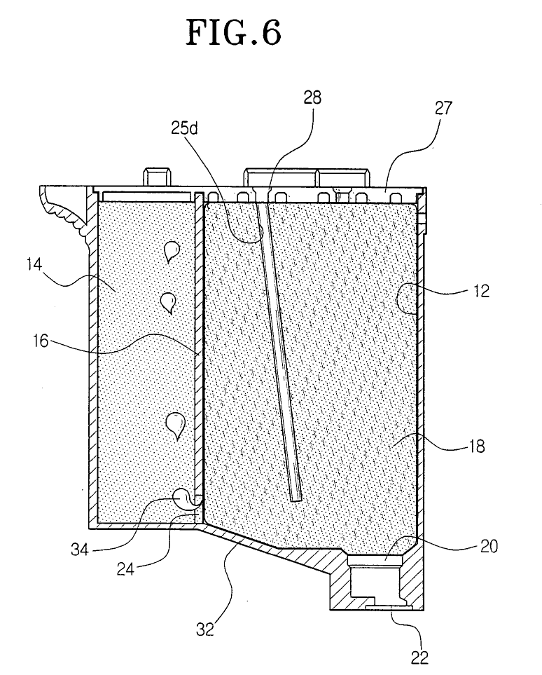

As shown in FIGS. 5 and 6, air passages 25c, 25d formed in the foam 18 may be disposed to slope such that a lower end thereof inclines toward the partition 16 more than an upper end thereof, and the upper ends inclines toward the partition 16 more than the lower ends, respectively.

When the lower end of the air passage 25c inclines toward the partition 16 as shown in FIG. 5, since the lower end of the air passage 25c is near the connecting opening 24, the air bubbles 34 have low resistance from the foam 18. Thus, the air bubbles 34 flow faster into the ink chamber 14. Conversely, the air bubbles 34 flow more slowly into the ink chamber 14 when the lower end of the air passage 25d is farther apart from the connecting opening 24, as shown in FIG. 6

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An ink cartridge with air inflowing regularly, comprising:
a foam chamber generating negative pressure, including a foam with an air passage formed from an upper end thereof toward a lower end, an ink filter and an ink head, wherein a part of a bottom of the foam chamber slopes down and the foam is disposed inside the foam chamber;
an ink chamber storing ink, disposed at one side of the foam chamber and divided from the foam chamber by a partition having a connecting opening connecting the ink chamber with the foam chamber; and
a cartridge cover closing upper ends of the ink chamber and foam chamber and having an ink inlet.

2. The ink cartridge according to claim 1, wherein the air passage is formed vertically and close to the partition.

3. The ink cartridge according to claim 1, wherein the air passage is disposed to slope such that a lower end thereof inclines toward the partition more than an upper end.

4. The ink cartridge according to claim 1, wherein a cross section of the air passage is substantially circular.

5. The ink cartridge according to claim 1, wherein a cross section of the air passage is substantially polygonal.

6. The ink cartridge according to claim 1, wherein the connecting opening is formed at a lowest end of the partition.

7. The ink cartridge according to claim 1, wherein the ink filter is disposed at a position lower than the connecting opening.

8. An ink cartridge with air inflowing regularly, comprising:
a cartridge defining an interior space having first and second chambers, the first chamber containing ink, and the second chamber containing foam and including a bottom sloping to an ink outlet;
a partition, separating the chambers, including an opening through which ink flows into the second chamber; and
an air passage in the foam from an upper end of the cartridge to a lower end, wherein the ink flows into the second chamber in response to the effect of negative pressure in the second chamber.

9. The ink cartridge according to claim 8, wherein the air passage is formed substantially vertically.

10. The ink cartridge according to claim 8, wherein the air passage is close to the partition.

11. The ink cartridge according to claim 8, wherein a distance between the air passage and the partition is larger near the upper end of the cartridge than at the lower end.

12. The ink cartridge according to claim 8, wherein a distance between the air passage and the partition is larger near the lower end of the cartridge than at the upper end.

13. The ink cartridge according to claim 8, wherein a cross section of the air passage is circular.

14. The ink cartridge according to claim 8, wherein a cross section of the air passage is polygonal.

15. The ink cartridge according to claim 8, wherein the opening is formed at a lowest end of the partition.

16. The ink cartridge according to claim 8, wherein the ink filter is lower than the opening.
